(19) United States
(12) Patent Application Publication
(10) Pub. No.: US 2019/0330489 A1
(43) Pub. Date: Oct. 31, 2019

(54) COMPOSITIONS BASED ON AQUEOUS POLYMER DISPERSIONS COMPRISING N-ALKYLPYRROLIDONES AND USE THEREOF

(71) Applicant: Dmitry Vasilievich DUKHOPELNIKOV, Novocherkassk (RU)

(72) Inventors: Dmitry Vasilievich DUKHOPELNIKOV, Novocherkassk (RU); Kaleria Klavdievna MOROZ, Rostov-na-Donu (RU); Natalya Ivanovna SIZOVA, Rostov-na-Donu (RU)

(73) Assignee: Dmitry Vasilievich DUKHOPELNIKOV, Novocherkassk (RU)

(21) Appl. No.: 16/174,798

(22) Filed: Oct. 30, 2018

(30) Foreign Application Priority Data
Apr. 26, 2018 (EA) 201890831

(51) Int. Cl. C09D 109/08; C09D 5/02; C09D 125/14; C09D 133/08

(52) U.S. Cl. CPC C09D 109/08; C09D 5/02; C08K 5/3415; C09D 133/08; C09D 125/14

(57) ABSTRACT

The invention relates to compositions based on an aqueous dispersion of one or more polymers and intended for coating various types of surfaces, including metal surfaces with oxide scale and rust. The compositions according to the inventions include a polymeric film-forming agent, preferably based on a synthetic polymer, with pH from 1.5 to 12.0, one or more phosphonic acids and water, as well as one or more compounds selected from N-alkylpyrrolidones. The composition includes a compound selected from N-alkylpyrrolidones in combination with phosphonic acids (such as NTPA and OEDPA) may produce a coating with a gloss, which is uncharacteristic for aqueous dispersion compositions, essentially higher adhesion to any substrates, and enhanced protective properties in aggressive media and in various climatic conditions.

### FIELD OF THE INVENTION

The present invention relates to the field of aqueous dispersion coating materials for coating metal surfaces, either clean or pre-treated, or having oxide scale and/or dense rust, as well as concrete and ferroconcrete surfaces, wood, gypsum plasterboard, slag blocks, etc. The invention may be used in various fields, in particular, those involving metal articles and constructions (machine building, boiler construction, railway transport, production of pipes of any diameter, bridges, power lines, bridge, portal, and tower cranes, building machines, automobile construction, etc.). The compositions according to the invention are fireproof, explosion-proof, and non-toxic.

### BACKGROUND OF THE INVENTION

It is known that aqueous dispersion coating compositions may comprise certain aqueous dispersions of synthetic polymers (latexes), for example, butadiene-styrene, styrene-acrylic or acrylic latexes as a film-forming component. In addition, they may comprise fillers, pigments, corrosion inhibitors, and other auxiliary additives.

Aqueous dispersion paints and compositions based on various latexes are known from the prior art. In particular, a latex composition according to Russian Federation Patent 2201427 of 27 Mar. 2003 comprises a film-forming agent (a mixture of a butadiene-styrene latex with a styrene-acrylic or acrylic latex), fillers, pigments, oxyphosphonic acid, liquid paraffin, non-ionic surfactant, and other auxiliary substances with the following ratios of the components (see Table 1).

TABLE 1

| Component | Amount, wt. % |
|---|---|
| Butadiene-styrene and/or styrene-acrylic latex or | 30.0-45.0 |
| mixtures thereof (in terms of a 50% dispersion) | |
| Filler | 10.0-28.0 |
| Pigment | 0.8-11.3 |
| Non-ionic surfactant | 0.3-0.4 |
| Oxyphosphonic acid | 1.84-1.9 |
| Hydroxyethyl cellulose | 0.01-0.5 |
| Liquid paraffin | 0.10-0.15 |
| Aerosil | 0.003-0.015 |
| Ethylene glycol | 8.6-11.0 |
| Water | Balance to 100 |

A disadvantage of the known composition is that it comprises an organic solvent, in particular, liquid paraffin (mineral spirit), as a defoamer. Further disadvantages of the known composition are a long formation of the coating taking at least 1 hour at 20±2° C. and impossibility of coating metal surfaces with oxide scale and dense rust.

Neither of other known aqueous dispersion paints has the whole aforesaid set of properties (see, for example, JPS 57-128756 (A)).

The prior art closest to the present invention is a rust-modifying primer according to Inventor's Certificate SU 1019842 A1, 7 May 1992 (the closest analog), which comprises a 49-51% aqueous dispersion of a synthetic polymer and a modifier, said modifier being nitrylotrimethylphosphonic acid or a salt thereof or a mixture of nitrylotrimethylphosphonic acid or a salt thereof and oxyethylidenedimethylphosphonic acid or a salt thereof in the ratio of 1:0.3-1 with the following ratios of the components (see Table 2).

TABLE 2

| Component | Amount, wt. %* |
|---|---|
| 49-51% synthetic polymer dispersion | 100.0 |
| Modifier | 1.0-20.0 |
| Water | 1.0-20.0 |

*Although SU 1019842 refers to weight percent, it would be more accurate to refer to weight parts as their sum does not equal 100.

The above composition makes the base of known rust modifying primer VD-KCh-0184 manufactured according to TU 6-33-5011902-107-91. When applied to a metal surface having oxide scale and dense rust, this material forms a priming coating, which is sufficiently resistant to corrosion. A disadvantage of the known composition is a low coating-substrate adhesion. Another disadvantage is a relatively long formation of the coating (at least 1 hour) under the standard conditions. Furthermore, this material is recommended for application to metal surfaces only. Moreover, addition of a pigment to such composition results in a high surface tension, thus requiring usage of a higher surfactant amounts and, consequently lowering the corrosion resistance of the coating.

In the prior art, there is a need in obtaining novel binding compositions and coating compositions, which would exhibit better flow properties and provide better wettability of the treated surface, higher coat forming speed, stronger adhesion to the surface and, consequently, higher stability of the formed coating.

### BRIEF SUMMARY OF THE INVENTION

The present inventors has found out that the aforementioned technical problem can be solved by using the compositions according to the present invention.

In the first aspect, the present invention relates to a universal composition comprising an aqueous dispersion of one or more polymers and one or more phosphonic acids or salts thereof, characterized in that said composition further comprises one or more compounds selected from N-alkylpyrrolidones. Such composition may be used for coating various surfaces or as a base for preparing such coating compositions, in particular, for preparing paintwork compositions, most preferably aqueous dispersion paints.

In the second aspect, the present invention relates to an aqueous dispersion paint composition comprising an aqueous dispersion of one or more polymers, one or more phosphonic acids or salts thereof, one or more pigments, and one or more fillers, characterized in that said composition further comprises one or more compounds selected from N-alkylpyrrolidones.

In the third aspect, the present invention relates to use of N-alkylpyrrolidone for preparing a composition based on an aqueous dispersion of one or more polymers and designed for coating. In a preferable embodiment, N-alkylpyrrolidone is used in combination with a phosphonic acid or a salt thereof.

In the fourth aspect, the present invention relates to a surface coating method including applying the composition according to the first and/or second embodiments of the invention to the surface.

In the fifth aspect, the present invention relates to a coated article, the coating comprising a polymeric film and one or more phosphonic acids or salts thereof, wherein the said coating is characterized in that it further comprises one or more compounds selected from N-alkylpyrrolidones.

Other aspects of the present invention will be apparent to those skilled in the art from the following description and the claims.

The technical effect of the present invention includes better flow properties of the coating compositions, better wettability of the treated surface, higher coat forming speed, stronger adhesion to the surface, as well as better stability and higher gloss of the formed coatings. The technical effect of the invention is achieved by adding one or more compounds selected from N-alkylpyrrolidones in combination with one or more phosphonic acids to the composition.

### DETAILED DESCRIPTION OF THE INVENTION

In the present invention, expressions «comprise» and «include» and derivatives thereof are used interchangeably and understood as non-limiting, i.e. allowing presence/use of other components, steps, conditions, etc., in addition to those explicitly mentioned. On the contrary, expressions «consist of» and «composed of» and derivatives thereof are intended to mean that the following list of components, steps, conditions, etc. is exhaustive.

In the present invention, when a range of possible values is given for any parameter, it is meant that the endpoints of the range are also included in the scope of the present invention. It is to be understood that all the sub-ranges encompassed by the given ranges are also included in the scope of the present invention as if they are disclosed explicitly. In case any parameter is provided with several ranges of possible values, all the ranges obtainable by combining various endpoints from said ranges are also included in the present invention as if they are disclosed explicitly.

In case any feature of the invention is disclosed herein for one embodiment, the same feature may be also used in all other embodiments of the invention, provided such use does not contradict the spirit of the invention.

In the present invention, the terms in a singular form also cover corresponding terms in plural form and vice versa, provided the context does not teach otherwise.

With the exception of the experimental part of the disclosure, all the numerical values expressing any amounts and conditions in the present invention are approximate values and should be read as preceded by the term «approximately» or «about», even if these terms are not explicitly present. On the contrary, all the numerical values in the experimental part are given as accurately as possible; however, it should be understood that any experimentally determined value intrinsically bears some error. Therefore, all the numerical values recited in the experimental part of this disclosure should be understood taking into account the existence of said experimental error and, at least, the number of the significant digits and standard rounding techniques.

Herein, all the percent values are weight/weight percent except where otherwise is said directly.

In the present invention, the terms «polymeric film-forming agent», «polymeric binder» and «polymer» are used interchangeably and mean particles of one or more polymers dispersed in an aqueous media (latexes), that act as a polymeric film-forming agent in the compositions according to the invention. Preferably, aqueous polymeric dispersions of the present invention are synthetic polymer dispersions (synthetic latexes). In the present invention, a wide range of various aqueous polymeric dispersions based on various synthetic rubbers may be used to prepare a composition according to the invention. In particular, in some embodiments, the polymers of the present invention may be polymers comprising styrene, butadiene, vinyl acetate, acrylic and other types of monomers, as well as any combinations thereof. In some embodiments of the invention, the polymers of the invention may comprise acrylic, styrene-acrylic, butadiene-nitrile, butadiene-styrene latexes or a combination thereof.

In some embodiments of the invention, pH of the aqueous polymeric dispersion may range from about 1.5 to about 12.0. That being said, in some embodiments, the lower limit of said range may be approximately 3.0, approximately 5.0, approximately 7.0, approximately 8.0, approximately 9.0 or approximately 11.0. On the other hand, in some embodiments, the upper limit of said range may be approximately 11.0, approximately 10.0, approximately 9.0 approximately 7.0, approximately 5.0, approximately 4.0 or approximately 3.0. Some specific embodiments may use acrylic latex MBM-5SP (pH 3.0-4.0) or MBM 5S (pH 3.0-5.0), styrene-acrylic latex Akremos-106 (pH 1.5-4.0), Ecolat 1210M (pH 3.0-5.0), Ecolat 1605 (pH 4.0-5.0), Novopol 009 (pH 3.0-5.0), Homakril (pH 8.0-9.0), butadiene-nitrile latex SKN-40 (pH 8.0-9.0) or butadiene-styrene latex BS-65 or BS-65A (pH 8.0-9.5) or SKS-65GP (pH 11.0-12.0), as well as a combination thereof.

According to the present invention, the total concentration of one or more polymers in a composition according to the invention may vary depending on specific components of said composition, the intended use of the composition and conditions of such use. For example, in some suitable embodiments, the total concentration of one or more polymers in the composition may range from about 10 to about 60 wt. % based on the total weight of the composition. That being said, in some embodiments, the lower limit of said range may be approximately 15, approximately 20, approximately 25, approximately 30, approximately 35, approximately 40 or approximately 45 wt. % based on the total weight of the composition. On the other hand, in some suitable embodiments, the upper limit of said range may be approximately 55, approximately 50, approximately 45, approximately 40, approximately 35, approximately 30 or approximately 25 wt. % based on the total weight of the composition. In case a composition according to the invention comprises a dispersion of more than one polymer in an aqueous medium, the weight ratio of these polymers may be selected by a skilled person in accordance with the practical and economic reasons taking into account the intended use of the composition and conditions of such use.

In the present invention, by «phosphonic acids» a class of compounds is understood, said compounds having one or more phosphonic acid functionalities and described by the following general formula:

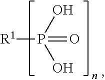

where R¹ is an optionally substituted C₁-C₃₀ (i.e., containing 1 to 30 carbon atoms) linear, branched or cyclic, saturated or unsaturated hydrocarbon moiety, and n is an integer that equals 1 or more, for example, an integer from 1 to 10. In the present invention, the expression «phosphonic acids» also covers salts of such acids.

Phosphonic acids are well known to those skilled in the art as agents that may be used in aqueous dispersion coating compositions. Some exemplary phosphonic acids that may be used in the present invention are, in particular, optionally substituted alkylphosphonic acids, alkylenediphosphonic acids, phenylphosphonic acids, vinylphosphonic acids, nitriltrialkylphosphonic acids (also referred to as amino trialkylenephosphonic acids), etc. Particularly preferable phosphonic acids suitable for use in the present invention are, in particular, oxyethylidenedimethylphosphonic acid, phenylphosphonic acid, vinylphosphonic acid, 1,12-dodecyldiphosphonic acid, aminotris(methylenephosphonic acid) (also referred to as nitrylotrimethylphosphonic acid), ethylenediamine tetramethylenephosphonic acid, etc. A skilled person will appreciate that mixtures of phosphonic acids may be also used in the invention. In a preferable embodiment, such mixture may be, for example, a mixture of nitrylotrimethylphosphonic acid (NTPA) and oxyethylidenedimethylphosphonic acid (OEDPA). In particular, in some embodiments, the weight ratio of NTPA:OEDPA in such mixture may range from about 0.1:1 to about 20:1, for example, from about 1:1 to about 10:1, from about 3:1 to about 7:1 or may be approximately 5:1.

Further, it should be noted that any of phosphonic acids used in the present invention may be present as a corresponding salt. Salts of phosphonic acids according to the invention may be formed by phosphonic acids as defined in the invention and ammonium, alkaline metals, alkaline earth metals and/or transition metals, such as lithium salt, sodium salt, potassium salt, calcium salt, ammonium salt, etc.

According to the present invention, the total concentration of one or more phosphonic acids or salts thereof in a composition according to the invention may vary depending on specific components of said composition, the intended use of the composition and conditions of such use, in particular, depending on pH of the latex. For example, in some suitable embodiments, the total concentration of one or more phosphonic acids or salts thereof in the composition may range from approximately 0.5 to approximately 15 wt. % based on the total weight of the composition. That being said, in some embodiments, the lower limit of said range may be approximately 1, approximately 2, approximately 3, approximately 4, approximately 5, approximately 6, approximately 8 or approximately 10 wt. % based on the total weight of the composition. On the other hand, in some suitable embodiments, the upper limit of said range may be approximately 12, approximately 10, approximately 8, approximately 6, approximately 5, approximately 4 or approximately 3 wt. % based on the total weight of the composition. In case the composition according to the invention comprises more than one phosphonic acid or salt thereof, the weight ratio of these phosphonic acids or salts thereof may be selected by a skilled artisan taking into account the surface properties and conditions (for example, existing oxide scale and/or dense rust) and application conditions in accordance with the practical and economic reasons.

In the present invention, N-alkylpyrrolidones (NAP) represent a class of compounds, where a pyrrolidone moiety is substituted at the nitrogen atom with a linear, branched or cyclic alkyl group containing 1 to 10 carbon atoms (i.e., C₁-C₁₀-alkyl group). Such compounds are known as solvents for polymers; however, N-alkylpyrrolidones have not been previously used in preparation of aqueous dispersion coating materials due to the risk of coagulation of the aqueous dispersions in synthetic latexes.

In a preferable embodiment of the present invention, N-alkylpyrrolidones are N-alkyl-2-pyrrolidones. In the present invention, the NAPs comprising linear or branched C₁-C₁₀-alkyl groups, more preferably linear or branched C₁-C₅-alkyl groups, even more preferably linear or branched C₁-C₃-alkyl groups, such as, for example, N-methyl-2-pyrrolidone, N-ethyl-2-pyrrolidone, N-propyl-2-pyrrolidone, N-isopropyl-2-pyrrolidone, are used. The inventors have unexpectedly found out that addition of one or more NAP compounds to an aqueous polymer dispersion results in a lower contact angle of the composition on the surface (i.e., an increase in the composition spreadability over the surface), an acceleration of the coating forming (i.e., removal of water from the coating), an increase in the coating adhesion to the substrate, and an enhancement of stability and gloss of the formed coating.

According to the invention, the total concentration of one or more N-alkylpyrrolidones in a composition according to the invention may vary depending on specific components of said composition, the intended use of the composition and conditions of such use. For example, in some suitable embodiments, the total concentration of one or more N-alkylpyrrolidones in the composition may range from about 0.05 to about 10 wt. % based on the total weight of the composition. That being said, in some embodiments, the lower limit of said range may be approximately 0.1, approximately 0.5, approximately 1, approximately 2, approximately 3, approximately 4, approximately 5, approximately 6 or approximately 8 wt. % based on the total weight of the composition. On the other hand, in some suitable embodiments, the upper limit of said range may be approximately 9, approximately 8, approximately 7, approximately 6, approximately 5, approximately 4 or approximately 2 wt. % based on the total weight of the composition. In case the composition according to the invention comprises more than one compound from the class of N-alkylpyrrolidones, the weight ratio of these compounds may be selected by a skilled person in accordance with the practical and economic reasons taking into account the intended use of the composition and conditions of such use.

In addition to the aforesaid components, the compositions according to the present invention may also comprise one or more components selected from fillers, pigments and auxiliary substances, in particular, fillers, pigments and auxiliary substances selected from those conventionally used in coating compositions, in particular, in paintwork compositions.

The exemplary suitable fillers are, in particular, alumosilicates, silicates, such as kaoline, talc, mica, alkaline earth carbonates, for example, calcium carbonate or magnesium carbonate, dolomite, alkaline earth sulfates, for example, calcium sulfate, titania, silica, etc. If the compositions use aqueous dispersion paints, the fillers may be used in the finely ground form. The fillers may be used individually; in practice, however, the fillers are more often used as a mixture, such as, for example, a mixture of talc, kaoline, and titania.

According to the present invention, the total concentration of one or more fillers in a composition according to the invention may vary depending on specific components of the composition, the intended use of the composition and conditions of such use. For example, in some suitable embodiments, the total amount of one or more fillers in the composition may range from about 1 to about 40 wt. % based on the total weight of the composition. That being said, in some embodiments, the lower limit of said range may be approximately 5, approximately 10, approximately 15, approximately 20, approximately 25, approximately 30 or approximately 35 wt. % based on the total weight of the composition. On the other hand, in some suitable embodiments, the upper limit of said range may be approximately 35, approximately 30, approximately 25, approximately 20, approximately 15, approximately 10, approximately 5 wt. % based on the total weight of the composition. In some embodiments, a filler may be absent in the composition of the invention. Such composition may, for example, be a base for the preparation of the paintwork compositions, preferably aqueous dispersion paints, or it may be, for example, a colorless varnish.

The exemplary suitable pigments for use in the present invention are inorganic substances, such as, for example, titania, zinc oxide, zinc sulfide, iron oxides, carbon black, etc., as well as organic pigments, such as, for example, indigo, azo dyes, anthraquinone pigments, phthalocyanine pigments, etc. The examples of pigments for use in the compositions of the invention may be coloring concentrates of PALIZH line.

According to the present invention, the total concentration of one or more pigments in a composition according to the invention may vary depending on specific components of the composition, the intended use of the composition and conditions of such use. For example, in some suitable embodiments, the total amount of one or more pigments in the composition may range from about 0.05 to about 15 wt. % based on the total weight of the composition. That being said, in some embodiments, the lower limit of said range may be approximately 0.1, approximately 0.5, approximately 1, approximately 2, approximately 3, approximately 5, approximately 7, approximately 9 or approximately 10 wt. % based on the total weight of the composition. On the other hand, in some suitable embodiments, the upper limit of said range may be approximately 12, approximately 10, approximately 8, approximately 6, approximately 5, approximately 4 or approximately 2 wt. % based on the total weight of the composition. In some embodiments, the compositions according to the invention may comprise no pigment. On the other hand, in case the composition according to the invention comprises more than one pigment, the weight ratio of these substances may be selected by a skilled person in accordance with the practical and economic reasons taking into account the intended use of the compositions and conditions of such use.

The exemplary auxiliary substances that may be used in the compositions according to the present invention, are solvents, additional film-forming agents, viscosity modifiers, wetting agents, dispersants, such as Rustan 10DN, preservatives, antifreezes, such as ethylene glycol, agents enhancing stability to electrolytes, biocides, defoamers, such as VUK defoamers, etc.

According to the present invention, the total concentration of one or more auxiliary substances in a composition according to the invention may vary depending on specific components of said composition, the intended use of the composition and conditions of such use. For example, in some suitable embodiments, the total amount of one or more auxiliary substances in a composition according to the invention may range from about 0.001 to about 15 wt. % based on the total weight of the composition. That being said, in some embodiments, the lower limit of said range may be approximately 0.01, approximately 0.1, approximately 0.5, approximately 1, approximately 2, approximately 5 or approximately 7 wt. % based on the total weight of the composition. On the other hand, in some suitable embodiments, the upper limit of said range may be approximately 12, approximately 10, approximately 7, approximately 5, approximately 2, approximately 1, approximately 0.5, approximately 0.1 or approximately 0.01 wt. % based on the total weight of the composition. In some embodiments, auxiliary substances may be absent in a composition according to the invention.

The compositions according to the invention may be prepared using the methods known from the prior art by mixing the components of the composition in an appropriate equipment designed for this purpose. For example, water, one or more phosphonic acids, and one or more N-alkylpyrrolidones may be mixed first. Then, if necessary, the mixture may be added with a filler and a dispersant, followed by a polymeric binder in the form of an appropriate aqueous dispersion, as well as, if necessary, a pigment and a defoamer. The component addition order may be modified if necessary.

The compositions according to the invention may be applied to surfaces using any method traditionally used in the art. In particular, in some embodiments, a composition according to the invention may be applied using pneumatic spraying, airless spraying, flow coating, immersion, brush, roller, blade device, etc. When coating is complete, the composition according to the invention is allowed to dry and form the final coating. The drying may be a result of the purposeful drying of the composition carried out using the methods known to a skilled person, and/or a result of natural evaporation of water present in the composition.

In one particular embodiment, the composition according to the invention is a composition comprising an aqueous dispersion of a polymer (latex), preferably having pH of 1.5 to 12.0, phosphonic acids (NTPA and OEDPA), and water, wherein said composition further comprises one or more compounds selected from N-alkylpyrrolidones and acting as an agent regulating the flow properties, adhesion to the treated surface, and coating forming parameters under natural conditions. Such exemplary composition is illustrated in Table 3:

TABLE 3
Universal composition 1 according to the invention

| Component | Amount, wt. % |
|---|---|
| Polymer | 20.0-40.0 |
| One or more phosphonic acids | 0.5-15.0 |
| One or more N-alkylpyrrolidones (NAP) | 0.05-10.0 |
| Water | balance |

To prepare pigmented compositions, universal composition 1 may be used as a base to be added with auxiliary substances, pigments and fillers. Aqueous dispersion paints represent one of the preferable embodiments of the pigmented compositions according to the invention.

Several illustrative examples are provided below for the aqueous dispersion paints according to the invention.

TABLE 4
Inventive aqueous dispersion paint 2 prepared using
butadiene-styrene latex
(pH 8.0-9.5)

| Component | Amount, wt. % |
|---|---|
| Butadiene-styrene polymer | 10.0-25.0 |
| One or more phosphonic acids | 0.5-15.0 |
| One or more N-alkylpyrrolidones (NAP) | 0.05-10.0 |
| Fillers (kaoline, talc, titania) and coloring concentrate | 15.0-35.0 |
| Auxiliary substances | 2.0-15.0 |
| Water | Balance |

TABLE 5
Inventive aqueous dispersion paint 3 prepared
using styrene-acrylic latex
(pH 3.5-5.0)

| Component | Amount, wt. % |
|---|---|
| Styrene-acrylic polymer | 10.0-25.0 |
| One or more phosphonic acids | 0.5-15.0 |
| One or more N-alkylpyrrolidones (NAP) | 0.05-10.0 |
| Fillers (kaoline, talc, titania) and coloring concentrate | 15.0-35.0 |
| Auxiliary substances | 2.0-15.0 |
| Water | Balance |

TABLE 6
Inventive aqueous dispersion paint 4 prepared using
a mixture of butadiene-styrene (pH 8.0-9.5) and
styrene-acrylate (pH 3.5-5.0) latexes

| Component | Amount, wt. % |
|---|---|
| Butadiene-styrene polymer | 5.0-12.5 |
| Styrene-acrylic polymer | 5.0-12.5 |
| One or more phosphonic acids | 0.5-15.0 |
| One or more N-alkylpyrrolidones (NAP) | 0.05-10.0 |
| Fillers (kaoline, talc, titania) and coloring concentrate | 15.0-35.0 |
| Auxiliary substances | 2.0-15.0 |
| Water | Balance |

TABLE 7
Inventive aqueous dispersion paint 5 prepared using
aqueous dispersion of acrylic polymer (pH 3.0-4.0)

| Component | Amount, wt. % |
|---|---|
| Acrylic polymer | 10.0-25.0 |
| One or more phosphonic acids | 0.5-15.0 |
| One or more N-alkylpyrrolidones (NAP) | 0.05-10.0 |
| Fillers (kaoline, talc, titania) and coloring concentrate | 15.0-35.0 |
| Auxiliary substances | 2.0-15.0 |
| Water | balance |

TABLE 8
Inventive aqueous dispersion paint 6 prepared
using butadiene-styrene latex
(pH 11.0-12.0)

| Component | Amount, wt. % |
|---|---|
| Butadiene-styrene polymer | 10.0-25.0 |
| One or more phosphonic acids | 0.5-15.0 |
| One or more N-alkylpyrrolidones (NAP) | 0.05-10.0 |
| Fillers (kaoline, talc, titania) and coloring concentrate | 15.0-35.0 |
| Auxiliary substances | 2.0-15.0 |
| Water | balance |

The proposed compositions are universal because they can form coatings with excellent physicochemical properties on various surfaces, such as metal (clean, pre-treated or having oxide scale or dense rust), concrete, wood, plastic, ceramic, glass, paper, gypsum, plaster, natural stone, brick, and other surfaces.

Filled (pigmented) compositions prepared as aqueous dispersion paints may be used to paint metal (clean, pre-treated or having oxide scale or dense rust (in particular, up to 100 μm thick or more), as well as concrete, ferroconcrete, and other surfaces. The paint compositions according to the present invention may be used for interior and exterior painting.

The non-pigmented universal base compositions, such as composition 1, may be used to treat wood surfaces, gypsum plasterboard, slag blocks, etc. Such compositions may be also used for interior and exterior painting.

The coatings prepared using the disclosed compositions may exhibit strong adhesion (1₁) according to cross-cut test method (State Standard GOST 15140) and low contact angle on the treated surfaces (see Table 10). The result is in better corrosion-proof properties of the coating in various climatic zones (see Table 11). Moreover, even if added in small amounts, N-alkylpyrrolidone significantly accelerates forming of the coating in ordinary conditions at 18-23° C.

Industrial conditions preparative examples of the inventive compositions are provided below. It should be understood that the examples are provided to illustrate the invention, and not do not limit the invention.

### EXAMPLES

### General Method of Preparing the Inventive Compositions

In a high-speed dissolver with a stirring rate 100 to 2000 rpm, an intermediate product is prepared consisting of water, phosphonic acids (NTPA and OEDPA in the ratio of 5:1), and N-methylpyrrolidone. The intermediate product is stirred for 15 min at 500 rpm, then fillers (TMK-28 talc, KO and KD type kaoline, R-02 and R-900 titania) and dispersant (Rustan 10DN) are added to the intermediate product through the charging port at the same stirring rate. The rotation speed of the stirrer is increased to 1500-2000 rpm. Samples for testing particle fineness are taken 2 hours after the start of the dispersing and then every hour. When the particle size of 20 μm (Klin grindometer) is achieved, the stirring rate is reduced to 100 rpm, and a 50% aqueous dispersion of the corresponding synthetic polymer, as well as a coloring concentrate (PALIZH), a defoamer (VUK-034) and ethylene glycol are added to the dissolver. The prepared composition is stirred for 30 min at 100 rpm to avoid a coagulation of latex. When stirring is finished, the composition is allowed to settle foam, and the product quality is evaluated in accordance with State Standard GOST 28196-89 «Aqueous dispersion paints. Specification (with Amendment No. 1)».

The above method was used to prepare and study compositions based on aqueous dispersions of various types. Table 9 represents examples of the inventive aqueous dispersion paints prepared from various aqueous dispersions of synthetic polymers (latexes) with pH ranging from 1.5 to 12.0.

TABLE 9
Components of the inventive compositions

| | Dispersion | Component amount in the composition, wt. % | | | | |
|---|---|---|---|---|---|---|
| Component | pH | Composition 2 | Composition 3 | Composition 4 | Composition 5 | Composition 6 |
| Butadiene- | 11.0-12.0 | 37.75 | — | 18.75 | — | 37.75 |
| styrene latex (50 wt. | 8.0-9.0 | | | | | |
| %) | | | | | | |
| Styrene-acrylic | 1.5-5.0 | — | 37.75 | 19.0 | — | — |
| latex | | | | | | |
| (50 wt. %) | | | | | | |
| Acrylic latex | 3.0-4.0 | — | — | — | 37.75 | — |
| (50 wt. %) | | | | | | |
| Phosphonic | | 4.2 | 3.0 | 4.2 | 3.0 | 6.0 |
| acids: | | | | | | |
| NTPA and | | | | | | |
| OEDPA | | | | | | |
| N-methyl-2- | | 4.35 | 4.0 | 4.35 | 4.0 | 7.0 |
| pyrrolidone | | | | | | |
| Dispersant | | 2.5 | 2.5 | 2.5 | 2.5 | 2.5 |
| Coloring | | 5.5 | 5.5 | 5.5 | 5.5 | 5.5 |
| concentrate | | | | | | |
| Fillers | | 22.5 | 22.5 | 22.5 | 22.5 | 22.5 |
| Defoamer | | 2.5 | 2.5 | 2.5 | 2.5 | 2.5 |
| Ethylene glycol | | 3.5 | 3.5 | 3.5 | 3.5 | 3.5 |
| Water | | 17.2 | 18.75 | 17.2 | 18.75 | 12.75 |

Table 10 shows the properties of the inventive compositions illustrated in Table 9 and physicomechanical properties of the coatings obtainable using the inventive compositions in comparison with Composition 8 of SU 1019842. Composition 8 was selected for the comparison because it exhibited the most advantageous combination of physicomechanical properties among the compositions disclosed in SU 1019842, in particular, the strongest adhesion to surfaces.

For testing the properties of the prepared coatings, test compositions were applied to the samples of degreased steel of St. 3 type having dimensions of 150 mm×70 mm with oxide scale and dense rust. The obtained coatings were tested in accordance with State Standard GOST 9.403-80 method A.

The composition viscosity was measures using a VZ-246 viscometer. The film hardness was measured using an M-3 type device. The film impact strength was measured using a U-1 type device.

TABLE 10
Properties of inventive compositions and physicomechanical properties of
the coatings based on inventive compositions in comparison with Composition 8 of
SU 1019842

| | Used composition | | | | | |
|---|---|---|---|---|---|---|
| | SU | | | | | |
| Property | 1019842 | Composition 2 | Composition 3 | Composition 4 | Composition 5 | Composition 6 |
| VZ-246 (nozzle 4 mm) | 15 | 20 | 30 | 25 | 30 | 15-18 |
| viscosity, sec | | | | | | |
| Degree 3 drying time | ≥60 | 45 | 15-20 | 30 | 10-15 | 30 |
| at (20 ± 2)° C., min | | | | | | |
| GOST 15140-78 | 2-3 | 2-3 | 1₁ | 1₁ | 1₁ | 2₁ |
| section 2 adhesion, | | | | | | |
| grade | | | | | | |
| M-3 (GOST 5233) | 0.3 | 0.3 | 0.4 | 0.35 | 0.5 | 0.3 |
| film hardness, a.u. | | | | | | |
| U-1 film impact | 50 | 50 | 50 | 50 | 50 | 50 |
| strength, cm | | | | | | |
| GOST 9.403 method A | 36 | 72 | 200 | 100 | 200 | 180 |
| water resistance, hour | | | | | | |
| GOST 9.403, method | 24 | 48 | 200 | 100 | 200 | 150 |
| A, salt resistance, hour | | | | | | |
| GOST 9.403 chemical | | | | | | |
| stability: | | | | | | |
| 38% H₂SO₄ | Unstable | Unstable | Stable | Unstable | Stable | Unstable |
| 40% NaOH | Unstable | Unstable | Stable | Unstable | Stable | Unstable |
| Wettability (contact | ≥70 | ≤60 | ≥30 | ≤40 | ≥30 | ≤40 |
| angle), deg | | | | | | |

As one can see from Table 9, the inventive compositions exhibited substantially higher film adhesion, hardness and strength, water resistance, salt resistance, and chemical stability to acids and alkalis, as well lower values of surface wettability and drying time as compared to the known composition.

Regarding the results of the comparative physicomechanical tests and tests of protective properties according to GOST 9.403 method A, Composition 5 prepared with 50% aqueous dispersion of acrylic polymer with pH 3.0-4.0 was selected for further climatic tests. The accelerated climatic tests were carried out at the Paintwork Research Institute (Khotkovo Paintwork Testing Laboratory). Steel St. 3 samples prepared according to State Standard GOST 9.402-91 were used for the climatic tests carried out according to State Standard GOST 9.401. Table 11 represents the climatic test results for the coatings obtained in accordance with the present invention.

TABLE 11
Accelerated climatic test results

| | GOST | | | | | | |
|---|---|---|---|---|---|---|---|
| | 9.401 | | | | | | |
| | testing | Test results, in cycles | | | | | |
| Coating | method | 1 | 5 | 10 | 15 | 20 | 25 |
| Composition 8 | Moderate | no | no | color | millet | pipe | peeling |
| of SU | climate | change | change | change, | rash | blisters | |
| 1019842 | | | | chalking | | | |
| Natural | Tropical | no | chalking | rash | pipe | peeling | Removed |
| drying, 60 μm | climate | change | | | blisters | | from the |
| thick | | | | | | | test |
| Inventive | Moderate | no | no | no change | no | no change | chalking |
| composition | climate | change | change | | change | | |
| (composition | Tropical | no | no | no change | no | no change | chalking |
| 5) Natural | climate | change | change | | change | | |
| drying, 60 μm | | | | | | | |
| thick | | | | | | | |

As one can see from Table 11, the inventive composition was characterized by substantially higher stability in the climatic test conditions.

Table 12 represents the test results of the inventive compositions and coatings prepared using the above method with various amounts of the polymeric binder, NAP, the phosphonic acids, and water.

TABLE 12

| | Component contents, wt. % | | | | | | | |
|---|---|---|---|---|---|---|---|---|
| | | | | | Parameters | | | |
| | | | | | | | GOST | |
| | 50% aqueous | | | | VZ-247 | | 9.401 stability, h | |
| | dispersion of | N-methyl-2- | NTPA + | | viscosity, | Adhesion, | | in 3% NaCl |
| Composition No. | acrylic polymer | pyrrolidone | OEDPA | water | sec | grade | in water | solution |
| 1 | 60.0 | 0.1 | 1.0 | 38.9 | 16 | 1 | 160 | 132 |
| 2 | 62.5 | 1.0 | 2.5 | 34.0 | 15 | 1 | 160 | 150 |
| 3 | 65.0 | 4.0 | 5.0 | 26.0 | 14 | 1 | 180 | 150 |
| 4 | 67.5 | 6.0 | 7.0 | 19.5 | 13 | 1 | 200 | 170 |
| 5 | 70.0 | 10.0 | 10.0 | 10.0 | 12 | 1 | 200 | 170 |

As one can see, all the test compositions exhibited an excellent viscosity, substrate adhesion, and climatic test stability according to GOST 9.401.

An essential feature of paintwork compositions is their storage stability. It is defined by the sedimentation (kinematic) stability when stored, and to this end, various structuring additives are usually added. The inventors have found out that N-alkylpyrrolidones (NAPs) act as rheological additives and do not only reduce the paint-substrate surface tension but also prevent agglomeration of the paint particles when stored.

The composition stability test was carried out by a laboratory method in a 2 dm³ standard polyethylene vessel. The presence of a deposit was controlled visually and with a wooden probe. No deposit was found in the inventive composition in the comparative test with composition 8 of SU 1019842. The test results are shown in Table 13. In parallel, the sedimentation stability test was carried out in larger vessels (50 and 100 dm³ polyethylene drums). Combined addition of NAP and phosphonic acids was found to increase the storage life of the aqueous dispersion paint by six months as compared to the term set in the technical documentation.

TABLE 13
Sedimentation stability test

| | | Composition numbers | | | |
|---|---|---|---|---|---|
| | | according to Table 9 | | | |
| Composition properties | SU 1019842 | 3 | 4 | 5 | 6 |
| VZ-246 viscosity at (20 ± 2)° C., sec | 15 | 20 | 30 | 30 | 25 |
| Hardly mixable deposit after | present | absent | absent | absent | absent |
| 1 month storage | | | | | |

1. A coating composition, said composition comprising an aqueous dispersion of one or more polymers and one or more phosphonic acids or salts thereof, wherein said composition further comprises one or more compounds selected from N-alkylpyrrolidones in the total amount ranging from about 0.05 to about 10 wt. % based on the weight of the composition.

2. The composition according to claim 1, wherein the aqueous dispersion of one or more polymers is an aqueous dispersion of a synthetic polymer having a pH from about 1.5 to about 12.0.

3. The composition according to claim 1, wherein said one or more polymers comprise styrene, butadiene, vinyl acetate, or acrylic monomers, or any combination thereof, and the total amount of said one or more polymers ranges from about 10 to about 60 wt. % based on the weight of the composition.

4. The composition according to claim 1, wherein said one or more phosphonic acids or salts thereof are nitrylotrimethylphosphonic acid, oxyethylidenedimethylphosphonic acid or salts thereof.

5. The composition according to claim 1, wherein said one or more phosphonic acids or salts thereof are present in the total amount from about 0.5 to about 15 wt. % based on the weight of the composition.

6. The composition according to claim 1, wherein said one or more compounds selected from N-alkylpyrrolidones are N-(C1-C₁₀-alkyl)-2-pyrrolidones.

7. The composition according to claim 1, wherein the composition is for coating metal, concrete, wood, plastic, ceramic, glass, paper, gypsum, plaster, natural stone, or brick surfaces.

8. An aqueous dispersion paint composition comprising an aqueous dispersion of one or more polymers, one or more phosphonic acids or salts thereof, one or more pigments, and one or more fillers, wherein said composition further comprises one or more compounds selected from N-alkylpyrrolidones in the total amount ranging from about 0.05 to about 10 wt. % based on the weight of the composition.

9. The composition according to claim 8, wherein the aqueous dispersion of one or more polymers is an aqueous dispersion of a synthetic polymer having a pH from about 1.5 to about 12.0.

10. The composition according to claim 8, wherein said one or more polymers comprise styrene, butadiene, vinyl acetate, or acrylic monomers, or any combination thereof, and the total amount of said one or more polymers ranges from about 10 to about 40 wt. % based on the weight of the composition.

11. The composition according to claim 8, wherein said one or more phosphonic acids or salts thereof are nitrylotrimethylphosphonic acid, oxyethylidenedimethylphosphonic acid or salts thereof.

12. The composition according to claim 8, wherein said one or more phosphonic acids or salts thereof are present in the total amount from about 0.5 to about 15 wt. % based on the weight of the composition.

13. The composition according to claim 8, wherein said one or more compounds selected from N-alkylpyrrolidones are N-(C₁-C₁₀alkyl)-2-pyrrolidones.

14. The composition according to claim 13, wherein said N-(C₁-C₁₀-alkyl)-2-pyrrolidone is N-methyl-2-pyrrolidone.

15. The composition according to claim 8, wherein the fillers are selected from kaoline, talc, mica, alkaline earth carbonates, alkaline earth sulfates, titania and silica, and wherein the fillers are present in the total amount from about 1 to about 40 wt. % based on the weight of the composition.

16. The composition according to claim 8, wherein the pigments are selected from inorganic and organic pigments, and wherein the pigments are present in the total amount from about 0.05 to about 15 wt. % based on the weight of the composition.

17. The composition according to claim 8, said composition further comprising one or more auxiliary substances selected from solvents, additional film-forming agents, viscosity modifiers, wetting agents, dispersants, preservatives, antifreezes, agents enhancing stability to electrolytes, biocides, and defoamers, wherein said auxiliary substances are present in the total amount from about 0.001 to about 15 wt. % based on the weight of the composition.

18. The composition according to claim 8, wherein the composition is for coating metal, concrete, wood, plastic, ceramic, glass, paper, gypsum, plaster, natural stone, or brick surfaces.

19. A coated article, wherein the coating comprises a polymeric film and one or more phosphonic acids or salts thereof, said coating further comprising one or more compounds selected from N-alkylpyrrolidones.

20. The article according to claim 19, wherein the coating comprises an aqueous dispersion of one or more polymers and one or more phosphonic acids or salts thereof, wherein said composition further comprises one or more compounds selected from N-alkylpyrrolidones in the total amount ranging from about 0.05 to about 10 wt. % based on the weight of the composition.
